(19) United States
(12) Patent Application Publication
(10) Pub. No.: US 2011/0299390 A1
(43) Pub. Date: Dec. 8, 2011

(54) RESOURCE AND ADMISSION CONTROL SUBSYSTEM AND METHOD THEREOF IN NGN

(75) Inventor: Enhui Liu, Shenzhen (CN)

(73) Assignee: Huawei Technologies Co., Ltd., Shenzhen (CN)

(21) Appl. No.: 13/208,353

(22) Filed: Aug. 12, 2011

Related U.S. Application Data
(63) Continuation of application No. 10/591,107, filed on May 22, 2008, now abandoned.

(30) Foreign Application Priority Data
Sep. 8, 2004 (CN) 200410074284.5

(51) Int. Cl. H04L 12/26

(52) U.S. Cl. 370/230

(57) ABSTRACT

A Resource and Admission Control Subsystem (RACS) in an NGN includes: a Resource Control Function in access network (A-RCF), an Access Admission Control Function (A-ACF), a Resource Control Function in core network (C-RCF), an Interconnection Admission Control Function (I-ACF), and corresponding interfaces. As a logically independent subsystem, RACS can support transport QoS requirements of multiple service subsystems (including IP multimedia service subsystem and PSTN/ISDN service emulation subsystem) simultaneously, implement QoS control for interconnecting links between different administrative domains, balance network load, prevent congestion (especially at bottle necks of network resources), support necessary measurement and protection mechanisms on the transport layer, and solve the problem of competition for transport resources among NGN traffics in the network administrative domains.

### CROSS REFERENCE TO RELATED APPLICATIONS

This application is a continuation of U.S. patent application Ser. No. 10/591,107, filed on May 22, 2008, The U.S. patent application Ser. No. 10/591,107 is a National Stage Entry of International Application No. PCT/CN2005/01426, filed on Sep. 8, 2005. The International Application claims priority to Chinese Patent Application No. 200410074284.5, filed on Sep. 8, 2004. The aforementioned patent applications are hereby incorporated by reference in their entireties.

### FIELD OF THE INVENTION

The present invention relates to Next Generation Network (NGN) technology, particularly to the functional framework, interface and control technique of a Resource and Admission Control Subsystem (RACS) in a NGN, and more particularly to a RACS and a method thereof in the NGN.

### BACKGROUND OF THE INVENTION

One of the characteristics of the Next Generation Network (NGN) is that the service layer is separated from the transport layer, and the transport layer is implemented on the basis of packet switching technology and optical technology. At present, the Telecommunication and Internet converged Services and Protocols for Advanced Networking (TISPAN) workgroup of European Telecommunications Standards Institute (ETSI) has established a functional framework of the NGN that supports a combination of fixed communication and mobile communication on the basis of IP Multimedia Subsystem (IMS) for the third generation mobile communication. As shown in FIG. 1, the framework includes a service layer and an IP-based transport layer.

The service layer includes a Network Attachment Subsystem (NASS), a Resource and Admission Control Subsystem (RACS), an IP Multimedia Subsystem (IMS), a PSTN/ISDN Emulation Subsystem (PES), other multimedia subsystems and applications, and common service components of these subsystems (such as application server, home mobile subscriber server, charging function, secure gateway, signaling gateway function, intercommunication function, and interconnect border control function, etc.)

Under the control of the NASS and RACS, the transport layer provides IP connectivity between NGN terminals, hides the transport technologies used on the layers under IP layer of access network and core network, and implements separation and interaction between the service layer and the transport layer. These subsystems can be distributed in the administrative domain of the network/service provider.

On the transport layer, only the Media Gateway Function (MGF) and the Border Gateway Function (BGF) may be possible to interact with the service layer. The BGF provides an interface between two IP transport domains, and may be located at the border of the customer premise network, of the access network or of the core network. The BGF terminates and interconnects L1 and L2 protocols at the interface between the two sides, and can provide the following functions:

gate opening and closing (the so-called “gate” refers to packet filtering in accordance with IP address/port);

packet marking for outbound traffic;

bandwidth reservation and allocation for inbound and outbound traffic;

IP address and port translation;

policing of inbound traffic;

packet filtering-based firewall; and

measurement of usage.

In order to control above functions as required by the service, the BGF may interact with the entities on the service layer. A residential BGF (R-BGF) is located at the border of the customer premise network; an access BGF (A-BGF) is located at the border of the access network; and an interconnect BGF (I-BGF) is located at the border of the core network.

The RACS is a critical component that supports end-to-end QoS control in an NGN environment; its position and external interface relationship in the overall NGN framework is shown in FIG. 2. The RACS must have interfaces to the transport layer, Network Management Function (NMF), NAS, IMS, PES, other service subsystems, and RACSs in other networks.

The RACS provides admission control and gate control functions (including network address port translation control and DSCP marking, etc.). The admission control covers checking authorization, operator-specific policy rules, and transport resource availability on the basis of the user profile stored in the NAS of access network. Transport resource availability check means the admission control function verifies whether the requested bandwidth matches the subscribed bandwidth and the used bandwidth of each subscriber.

FIG. 2 shows the position of RACS in the overall framework of NGN and its external interface relationship. Due to the diversity and multimedia feature of NGN services, it is a necessary task to investigate how the IP-based transport layer can provide end-to-end QoS better than Best Effort transport service and comparable to the PSTN in the NGN research work. Since the RACS is a crucial subsystem for supporting end-to-end control in the NGN framework, it is required to investigate the external interface and internal functional framework of RACS.

### Technical Solution of Prior Art 1:

A Policy Decision Function (PDF) is specified in TS 23.207 of 3GPP R6, in order to support end-to-end QoS control in UMTS domain, as shown in FIG. 3. The PDF is connected to the application function (AF) via a Gq interface, and connected to the Traffic Plane Function (TPF) via a Go interface. In addition, flow-based charging in the Charging Rules Function (CRF) is considered in TS.23.125; the CRF is connected to AF via a Rx interface and connected to TPF via a Gx interface.

The control point of the Go interface for TPF is on the gateway at the border of the core network, i.e., GGSN; a charging control function; an Application Function (AF), which requires application function of IP bearer resource control (e.g., P-CSCF in IMS); a Charging Collection Function (CCF); an Online Charging System (OCS); and a Policy Decision Function (PDF), as shown in FIG. 3.

For 3GPP IP multimedia service, the end-to-end QoS framework is shown in FIG. 4. In the IP backbone network, QoS is assured by means of Diffsery mechanism and high bandwidth; in the UMTS access network (i.e., from UE to GGSN), the QoS of IP bearer services is assured by means of PDP context. The PDF interacts with AF and GGSN and performs admission control on the basis of the subscriber service agreement and management policy, so as to control DiffSery forwarding at GGSN. The PDF follows the policy control framework established by IETF RAP Group.

QoS control is accomplished in three segments: the local UMTS access network, the IP backbone network, and the remote subscriber access network.

In order to implement end-to-end QoS, the QoS control mechanisms in the local UMTS access network, the IP backbone network, and the remote subscriber access network can interact with each other in the following approaches: (1) messaging along the data flow path (e.g., RSVP and LDP); (2) intercommunication between policy control or resource management units; (3) service level agreement execution at border routers in the networks.

Therefore, the end-to-end QoS framework in 3GPP TS 23.207 mainly specifies the QoS control mechanism and PDF in UMTS domain, but it specifies neither the QoS control framework and mechanism in the backbone network nor the end-to-end QoS framework and mechanism for intercommunication with the UMTS external network.

### Disadvantages of Prior Art 1:

The Policy Decision Function (PDF) performs admission control and gate control merely on the basis of subscriber service agreement and management policy, but it does not check availability of network resources (including competition for shared resources) on the basis of resource status; therefore, it can't solve the QoS problem resulted from resources competition and overload on IP bearer layer at the border between the UMTS access network and the core network.

The IP core network relies on DiffSery mechanism and high bandwidth, but it does not define a resource control function framework; therefore, it cannot provide QoS assurance required for real-time services.

End-to-end QoS assurance is unavailable because there is no end-to-end QoS framework and mechanism for intercommunication with the UMTS external network.

### Technical Solution of Prior Art 2:

ITU-T J.163 describes a dynamic QoS model in a Cable IP access network (IPCablecom), as shown in FIG. 5. The Call Management Server (CMS) controls multimedia session setup and maintains status of each call. The Gate Controller (GC), as a part of CMS, performs QoS functional part, performs QoS admission control, and controls gate operation in the Cable Modem Termination System (CMTS) via a pkt-q6 interface. The GC provides policy decision point function, following the policy control framework specified by the IETF RAP Group.

QoS management is divided into three segments: a Cable IP access network at start side, an IP backbone network, and a Cable access network at terminal side.

QoS in the Cable IP access network is controlled with the QoS parameters carrying traffic and flow specifications as specified in J.112. The QoS objects carried in these parameters are similar to TSPEC and RSPEC objects carried in RSVP, so as to support dynamic flow-based QoS resource reservation. The flows may be unidirectional or bidirectional.

In the IP core network, Diffsery mechanism is used to ensure QoS. RSVP can be used to transmit multimedia service QoS requests in an end-to-end manner.

CMSs implement session control and resource coordination with each other via a pkt-q8 interface. The resource management in the backbone network may be per-flow or aggregated, which is not specified in J.163.

Gate is a construction that defines QoS operations in CMTS and is a control point that controls whether the access network can be connected to a high quality backbone service network. A Gate includes a packet classifier, a traffic policer, and an interface for acquisition of statistical information. Gate control can ensure only sessions authorized by the service provider are served at a high quality. Gate control operations are applied to each call data flow, to open or close the gate. When a gate is to be opened, the GC has to perform admission control check in accordance with a resource management request from the client; and if necessary, resources for the session in the network may be reserved.

### Disadvantages of Prior Art 2:

The Gate Controller (GC) is integrated in CMTS; therefore, the GC requires high upgrade costs to provide new multimedia services and can't support the QoS requirements of any other traffic control entity.

The Gate Controller (GC) performs admission control and gate control merely on the basis of subscriber service agreement and management policy but doesn't check availability of network resources (including competition for shared resources) on the basis of resource status. Therefore, it can't solve the QoS problem resulted from resources competition and overload on IP bearer layer at the border between the Cable access network and the core network.

The IP core network relies on DiffSery mechanism and high bandwidth but doesn't specify a resource control function framework, and thus can't provide QoS assurance required for real-time services.

End-to-end QoS assurance is unavailable because no end-to-end QoS framework and mechanism for intercommunication with the Cable external network is specified.

### SUMMARY OF THE INVENTION

An object of the present invention aims to provide a Resource

Admission and Control Subsystem (RACS) in an NGN and a method thereof. Based on the RACS functional framework as provided, a method for authentication and admission control decision making is provided for resource reservation requests by RACS, i.e., a method for end-to-end QoS control by RACS at media flow level. As a logically independent subsystem, RACS can support transport QoS requirements of multiple service subsystems (including IP multimedia service subsystem and PSTN/ISDN service emulation subsystem) simultaneously, implement QoS control for interconnecting links between different administrative domains, balance network load, prevent congestion (especially at bottle necks of network resources), support necessary measurement and protection mechanisms on the transport layer, and solve the problem of competition for transport resources among NGN traffics in the network administrative domains.

The technical solution according to an aspect of the present invention is as follows:

A resource and admission control subsystem in an NGN including: a Resource Control Function in access network (A-RCF), an Access Admission Control Function (A-ACF), a Resource Control Function in core network (C-RCF), an Interconnection Admission Control Function

(I-ACF), and

a Gq interface: the application service control function in each NGN application service subsystem interacts with the A-ACF via the Gq interface, to send the resource reservation request of the application service media flow for the transport layer to the A-ACF;

a Go interface: the A-ACF controls an Access Border Gateway Function (A-BGF) via the Go interface;

a G3 interface: the I-ACF controls an Interconnection Border Gateway Function (I-BGF) via the G3 interface;

a G2 interface: the C-RCF acquires resource status information in the core network via the G2 interface, and controls a Traffic Plane Function in core network (C-TPF);

a G1 interface: the A-RCF acquires resource status information in the access network, and controls a Traffic Plane Function in the access network (A-TPF) via the G1 interface;

X1 and X2 interfaces: the A-ACF interacts and coordinates with the A-RCF via the X1 interface and with the C-RCF via the X2 interface, to implement end-to-end transport resource availability checking and QoS control for application service media flows in the operator network.

X3 and X4 interfaces: the I-ACF interacts with the C-RCF via the X3 interface, to implement end-to-end transport resource availability checking and QoS control for application service media flows across operator networks; the I-ACF interacts with RACSs in other operator networks via the X4 interface, to forward resource reservation requests of application service media flows across operator networks;

an I1 interface: the A-ACF interacts with a Network Attachment SubSystem (NASS) via the I1 interface, to obtain user profiles;

an Id interface: an Interconnection Border Control Function (IBCF) interacts with the I-ACF via the Id interface, to send the resource reservation request of cross-operator application service media flow for the transport layer to the I-ACF.

The A-BGF receives admission control parameters from the Go interface and performs such functions as gate operations, packet marking, bandwidth allocation, network address and port translation, traffic policing for the application service media flow in accordance with the admission control parameters;

the I-BGF receives admission control parameters from the G3 interface and performs such functions as gate operations, packet marking, bandwidth allocation, network address and port translation, and traffic policing for the cross-operator application service media flow in accordance with the admission control parameters;

the C-RCF acquires transport resource status information (e.g., topology and bandwidth, etc.) in the core network via the G2 interface, and controls QoS route and resource reservation in the C-TPF;

the A-RCF acquires transport resource status information (e.g., topology and bandwidth, etc.) in the access network via the G1 interface, and controls QoS route and resource reservation in the A-TPF.

After receiving a resource reservation request via the Gq interface, the A-ACF performs authentication to check whether the resource reservation request conforms to operation policy rules, obtains user profiles related with the service via the Il interface, and checks whether the resource reservation request conforms to the user profiles;

if a Resource Control Function in access network (A-RCF) is provided, the A-ACF forwards the resource reservation request to the A-RCF via an X1 interface to check the transport resource availability in the access network (i.e., to check whether there are enough transport resources available in the access network to meet the resource reservation request), and obtains the check result of transport resource availability in the access network from the A-RCF; the check result carrying QoS class, bandwidth and ingress path information assigned to the application service media flow;

if the application service media flow is towards the core network and a Resource Control Function in core network (C-RCF) is provided, the A-ACF forwards the resource reservation request to the C-RCF via an X2 interface to check the transport resource availability in the core network (i.e., to check whether there are enough transport resources available in the core network to meet the resource reservation request), and obtains the check result of transport resource availability in the core network from the C-RCF; wherein the check result may carry such information as QoS class, bandwidth and ingress path information assigned to the application service media flow.

After receiving a resource reservation request via the Id interface, the

I-ACF checks whether the resource reservation request conforms to Service Level Agreements (SLA), the operation policy rules, and transport resource availability of interconnecting links between operators (i.e., to check whether each interconnecting link has enough transport resources available to meet the resource reservation request);

if the application service media flow is towards the core network and a C-RCF is provided in the core network, the I-ACF forwards the resource reservation request via the X3 interface to the C-RCF, so as to check the transport resource availability in the core network (i.e., to check whether there are enough transport resources available in the core network to meet the resource reservation request), and obtains the check result of transport resource availability in the core network from the C-RCF; wherein, the check result may carry such information as QoS class, bandwidth and ingress path information assigned to the application service media flow.

After receiving a resource reservation request, the A-ACF makes an admission control decision (i.e., whether to permit the application service media flow to enter into the network and whether the QoS requirement parameters specified in the resource reservation request are met) and determines the admission control parameters for the application service media flow (including such information as gate control, bandwidth allocation, QoS class, and ingress path), in accordance with the check result of user profiles, the check result of operation policy rules, and the check result of transport resource availability;

the A-ACF returns the authentication and admission control decision result for the resource reservation request to the application service control function via the Gq interface;

if the admission control decision result is “permit”, the A-ACF sends the admission control parameters to the A-BGF actively, or the A-BGF requests for the admission control parameters from the A-ACF via the Go interface; the A-BGF performs such functions as gate operations, bandwidth allocation, packet marking, and traffic policing for the application service media flow in accordance with the admission control parameters.

After receiving a resource reservation request, the I-ACF makes an admission control decision (i.e., whether permits the media flow of the cross-operator application service to enter into the network and whether the QoS requirement parameters specified in the resource reservation request are met) and determines the admission control parameters (including gate control, bandwidth allocation, QoS class, and ingress route information) for the media flow of the cross-operator application service, in accordance with the check result of SLA, the check result of operation policy rules, and the check result of transport resource availability between operators;

the I-ACF returns the authentication and admission control decision results for the resource reservation request to the IBCF via the Id interface;

if the admission control decision result is “permit”, the I-ACF sends the admission control parameters to the I-BGF actively, or the I-BGF requests for the admission control parameters from the I-ACF via the G3 interface; the I-BGF performs gate operations, bandwidth allocation, packet marking, and traffic policing for the application service media flow in accordance with the admission control parameters.

Another aspect of the present invention provides a method for resource and admission control in an NGN, wherein an Access Admission Control Function (A-ACF) performs authentication and makes an admission control decision for a resource reservation request in accordance with user profiles (stored in NASS), operation policy rules, and transport resource availability, and controls an Access Border Gateway Function (A-BGF) at the border between the access network and the core network via a Go interface in accordance with the admission control decision result;

an Interconnection Admission Control Function (I-ACF) performs authentication and makes an admission control decision in accordance with Service Level Agreements (SLA), operation policy rules, and transport resource availability between operators, and controls an Interconnection Border Gateway Function (I-BGF) at the border of core networks via a G3 interface in accordance with the admission control decision result;

a Resource Control Function in access network (A-RCF) acquires status information of transport resources in the access network via a G1 interface, controls resource reservation in the network, maintains a database of transport resource availability and resource allocation status data, checks the transport resource availability in accordance with the request from the A-ACF, performs checking and resource allocation on the basis of the resource status database, updates resource allocation status, and returns the check result of transport resource availability;

a Resource Control Function in core network (C-RCF) acquires status information of transport resources in the core network via a G2 interface, controls resource reservation in the network, maintains a database of transport resource availability and resource allocation status, checks the transport resource availability in accordance with the request from the A-ACF or the I-ACF, performs checking and resource allocation on the basis of the resource status database, updates resource allocation status and returns the check result of transport resource availability.

The A-ACF controls the A-BGF at the border of the access network via a Go interface to perform the following steps for the media flow in accordance with the admission control decision result: 1. gate opening or closing (“gate” indicates packet filtering by IP address/port); 2. packet marking for outbound traffic; 3. bandwidth reservation and allocation for inbound/outbound traffic; 4. IP address and port translation; 5. policing of inbound traffic; 6. packet filtering-based firewall; 7. measurement of usage.

The I-ACF controls the I-BGF at the border of the core network via the G3 interface to perform the following steps in accordance with the admission control decision result: 1. gate operations; 2. packet marking; 3. resource reservation; 4. network address and port translation; 5. traffic policing.

The status information of transport resources in the network includes: network topology, physical or logical link bandwidth, etc.

In each network administrative domain, a centralized RCF or multiple RCFs distributed in sub-domains can be provided in accordance with the network scale and packet bearing technique, and backup RCFs can be provided to improve reliability.

If multiple RCFs distributed in the sub-domains are provided in an administrative domain, the RCFs can interact and coordinate with each other via a universal and extensible protocol interface, so as to accomplish the checking of end-to-end transport resource availability for the resource reservation requests across the entire administrative domain.

RCFs in different network administrative domains are usually interconnected via an ACF. Transport resource availability check requests and results are sent between ACFs and RCFs via a universal and extensible protocol interface.

If there is a trusting relationship between different network administrative domains, RCFs in the different network administrative domains can interface to each other directly and exchange information with each other, just like in a single administrative domain.

Both ACF and RCF are logical functions, which can be separate physical devices or functional modules integrated in other physical devices.

For application service in an operator network, a Resource and Admission Control Subsystem (RACS) performs end-to-end QoS control via the steps of:

during the process of creating the application service, the application service control function determines the resource reservation requirements of the application service media flow and sends the requirements to the A-ACF at initiating end and destination end via the Gq interface, respectively;

when receiving the resource reservation request, the A-ACF performs authentication and makes an admission control decision for the resource reservation request with the method;

the A-ACF returns the authentication and admission control decision result for the resource reservation request to the application service control function via the Gq interface;

if the admission control decision is “permit”, the A-ACF sends admission control parameters to the A-BGF in push or pull mode via the Go interface, to control gate operations, packet marking, and traffic policing at the A-BGF.

For an application service across operator networks, the RACS performs end-to-end QoS control via the steps of:

during the process of creating the application service, the application service control function determines the resource reservation requirements of the application service media flow and sends the requirements to the A-ACF via the Gq interface; an Interconnection Border Control Function (IBCF) determines the resource requirements of application service media flow and sends the requirements to the I-ACF via an Id interface;

when receiving the resource reservation request, the A-ACF performs authentication and makes an admission control decision for the resource reservation request with the method;

when receiving the resource reservation request, the I-ACF performs authentication and makes an admission control decision for the resource reservation request with the method;

the A-ACF returns the authentication and admission control decision result for the resource reservation request to the application service control function via the Gq interface;

the I-ACF returns the authentication and admission control decision result for the resource reservation request to the IBCF via the Id interface;

if the admission control decision is “permit”, the A-ACF sends admission control parameters to the A-BGF in push or pull mode via the Go interface, to control gate operations, packet marking, and traffic policing at the A-BGF;

if the admission control decision is “permit”, the I-ACF sends admission control parameters to the I-BGF in push or pull mode via the G3 interface, to control gate operations, packet marking, and traffic policing at the I-BGF.

The method for resource and admission control according to an aspect of the present invention enables modification of resource reservation in the application service session. The application service control function sends a resource reservation modification request to the A-ACF via the Gq interface; if it is a cross-operator application service, the IBCF sends the resource reservation modification request to the I-ACF via the Id interface; the A-ACF and I-ACF modify the original resource reservation and admission control parameters.

The method for resource and admission control according to an embodiment of the present invention requires that the resource reservation should be released after the application service is completed. The application service control function sends a resource release request to the A-ACF via the Gq interface; if it is a cross-operator application service, the IBCF sends the resource release request to the I-ACF via the Id interface; the A-ACF and I-ACF release all resource reservation and admission control parameters.

It is seen from above technical solution according to an embodiment of the present invention: the functional framework and method for resource and admission control according to an embodiment of the present invention supports end-to-end QoS control at media flow level and has no limitation on the packet switching technique used on the transport layer in the access network and the core network. The functions intercommunicate with each other via a universal and extensible protocol interface, independent of the configuration and deployment of physical devices.

### BRIEF DESCRIPTION OF THE DRAWINGS

FIG. 1 shows an overall framework of a TISPAN NGN;

FIG. 2 shows a position of RACS in the NGN framework and the external interface relationships of the RACS;

FIG. 3 shows interfacings between PDF and other functions;

FIG. 4 shows a PDF-based end-to-end QoS framework in 3GPP IMS;

FIG. 5 shows a dynamic QoS model in IPCablecom; and

FIG. 6 shows a functional framework and interfaces of RACS according to an embodiment of the present invention.

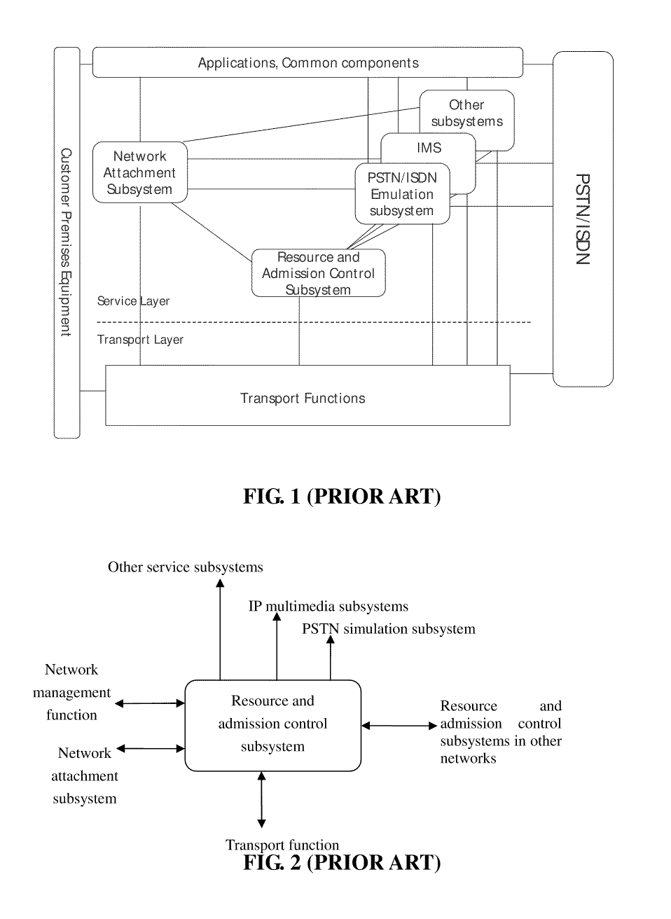

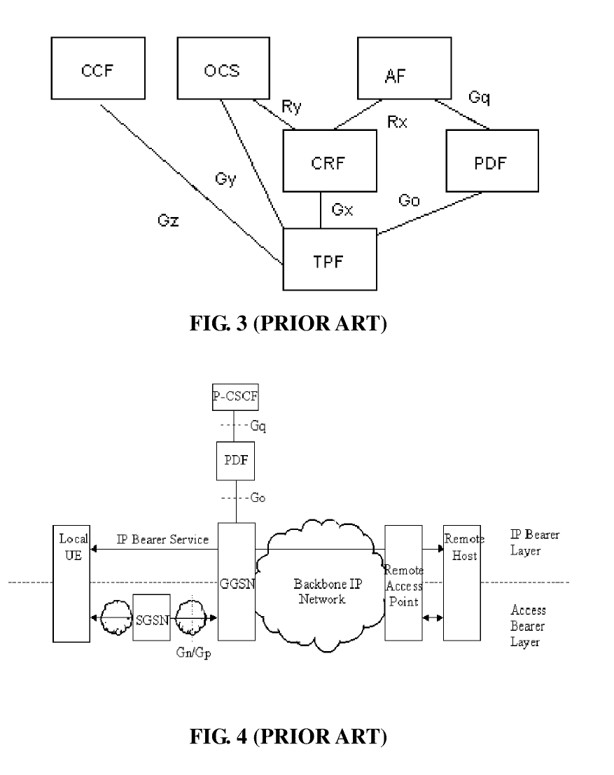

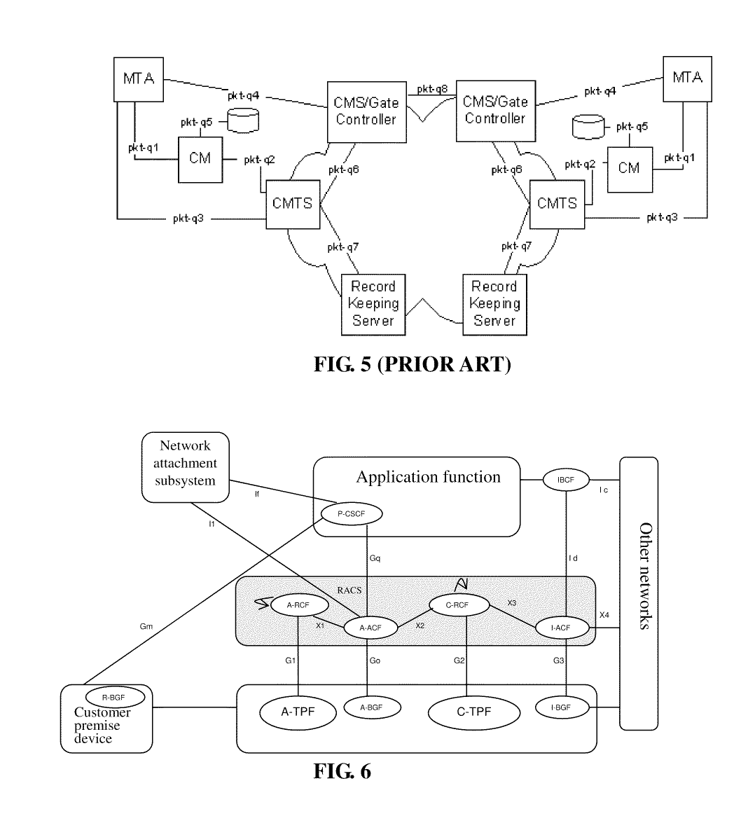

### DETAILED DESCRIPTION OF THE EMBODIMENTS

Hereinafter the embodiments of the present invention are described with reference to the attached drawings. As a logically independent subsystem, the Resource Admission and Control Subsystem (RACS) can support transport QoS requirements of multiple service subsystems (including IP multimedia service subsystem and PSTN/ISDN service emulation subsystem) simultaneously. An embodiment of the present invention provides a functional framework and internal and external interfaces of the RACS, a method for authentication and admission control decision making for resource reservation request by the RACS, and a method for end-to-end QoS control by the RACS at the media flow level.

On the basis of the Access Admission Control Function (A-ACF) at the edge of an operator network, an embodiment of the present invention provides an Interconnection Admission Control Function (I-ACF) at the network border, in order to implement QoS control for the interconnecting links between different network administrative domains. The ACF can have network address translation and port translation (NAPT) functions.

In order to solve the problem of competition for transport resources between NGN traffics in the network administrative domains, an embodiment of the present invention provides a resource control function (CF) for network resource availability checking, QoS routing and resource reservation, so as to balance network load and prevent congestion (especially at bottle necks of network resources) and support necessary measurement and protection mechanisms on the transport layer.

In an embodiment of the present invention, the Admission Control Function (ACF) and the Resource Control Function (RCF) have no limitation on the packet switching technique used on the transport layer in the access network and the core network.

The RACS functional framework according to an embodiment of the present invention is shown in FIG. 6, and it defines the internal interfaces between the functions and the external interfaces to external components, wherein:

R-BGF—Residential Border Gateway Function;

NASS—Network Attachment SubSystem;

P-CSCF—Proxy Call Session Control Function;

IBCF—Interconnection Border Control Function;

ACF—Access ACF;

ACF—Interconnection ACF;

RCF—RCF in access network;

RCF—RCF in core network;

BGF—Access BGF;

BGF—Interconnection BGF;

TPF—TPF in access network;

TPF—TPF in core network;

The RACS shown in FIG. 6 includes Admission Control Functions

(ACFs) and Resource Control Functions (RCFs).

The Admission Control Functions (ACFs) are distributed at the edge of the operator network and the border between operator networks. Wherein, the Access Admission Control Function (A-ACF) performs authentication and makes admission control decisions for resource reservation requests of application service media flows, based on user profile (stored in NASS), operation policy rules and transport resource availability, and controls the A-BGF at the border between the access network and the core network via a Go interface to perform the following operations in accordance with the admission control decision result: 1) gate opening or closing (“gate” indicates packet filtering by IP address/port); 2) packet marking for outbound traffic; 3) bandwidth reservation and allocation for inbound and outbound traffic; 4) IP address and port translation; 5) policing of inbound traffic; 6) packet filtering-based firewall; and 7) measurement of usage.

The Interconnection Admission Control Function (I-ACF) performs authentication and makes admission control decisions for resource reservation requests of media flows of cross-operator application services in accordance with the SLA between operators, operation policy rules, and transport resource availability, and controls the I-BGF at the border of the core network via a G3 interface, in accordance with the admission control decision result, to perform gate operations, packet marking, resource reservation, network address and port translation, and traffic policing, etc.

The Resource Control Functions (RCFs) are distributed in the network administrative domains, such as domains in the access network and domains in the core network.

Wherein, the RCF in access network (A-RCF) acquires status information (such as topology and bandwidth, etc) of transport resources (i.e., A-TPF) in the access network via a G1 interface, controls QoS-related traffic handling and resource reservation activities of A-TPF in the network, maintains a database of transport resource availability and resource allocation status, checks the transport resource availability in accordance with the request from the A-ACF, performs checking and resource allocation on the basis of the resource status database, updates resource allocation status and returns the check result of transport resource availability.

The RCF in core network (C-RCF) acquires status information of transport resources (such as topology and bandwidth, etc) in the core network (i.e., C-TPF) via a G2 interface, controls QoS-related traffic handling and resource reservation activities of C-TPF in the network, maintains a database of transport resource availability and resource allocation status, checks the transport resource availability in accordance with the request from the A-ACF or I-ACF, performs checking and resource allocation on the basis of the resource status database, updates resource allocation status and returns the check result of transport resource availability.

In each network administrative domain, a centralized RCF or multiple RCFs distributed in the sub-domains can be provided in accordance with the network scale and packet bearing technique, and backup RCFs can be provided to improve reliability. Since the transport technology and data plane QoS mechanism in each network administrative domain may be different from others, RCFs may be implemented in different ways accordingly, for example, RCF in IP network, RCF in MPLS network, RCF in Ethernet, and RCF in ASON network.

If multiple RCFs distributed in the sub-domains are provided in a network administrative domain, the RCFs can interact and coordinate with each other via a universal and extensible protocol interface, so as to accomplish the checking of end-to-end transport resource availability for resource reservation requests across the entire administrative domain.

Two RCFs in different network administrative domains are usually interconnected via an ACF. Transport resource availability check requests and results are sent between ACFs and RCFs via a universal and extensible protocol interface. If there is a trusting relationship between different network administrative domains, RCFs in the different network administrative domains can interface with each other directly and exchange information with each other, just like in a single administrative domain.

Both ACF and RCF are logical functions, and their physical implementation is not limited (e.g., they may be separate physical devices or functional modules integrated in other physical devices). As for compatibility, the PDF in 3GPP IMS and the GC in IPCableCom can be regarded as different implementing examples of the A-ACF in different types of access networks; the Bandwidth Broker (BB) in Internet 2/MSF can be regarded as an implementing example of the C-RCF in IP network.

Gq interface: in NGN application service subsystems, for resource control on the transport layer, an application service control function (e.g., P-CSCF in IP multimedia subsystem) is required to send resource reservation requirements of application service media flows for the transport layer initiated from the operator network to the A-ACF in RACS via a Gq interface. The interface can be identical or compatible to the Gq interface specified in 3GPP R6 IMS.

Go interface: the A-ACF controls the A-BGF via a Go interface to perform gate operations, packet marking, resource reservation, network address and port translation, and traffic policing, etc. This interface can be identical or compatible to the Go interface specified in 3GPP R6 IMS.

G3 interface: the I-ACF controls the I-BGF via a G3 interface to perform gate operations, packet marking, resource reservation, network address and port translation, and traffic policing, etc. The G3 interface is a new interface specified in an embodiment of the present invention.

G2 interface: the C-RCF acquires information such as topology and bandwidth of transport resources in the core network and controls QoS-related traffic handling and resource reservation activities of the C-TPF via a G2 interface. The G2 interface is a new interface specified in an embodiment of the present invention.

G1 interface: the A-RCF acquires information such as topology and bandwidth of transport resources in the core network and controls QoS-related traffic handling and resource reservation activities of the A-TPF via a G1 interface. The G1 interface is a new interface specified in an embodiment of the present invention.

X1 and X2 interfaces: the Access ACF (A-ACF) interacts and coordinates with the RCF in access network (A-RCF) via an X1 interface, and interacts and coordinates with the RCF in core network (C-RCF) via an X2 interface, to perform end-to-end transport resource availability checking and QoS control for resource reservation requirements of application service media flows in the operator network, and provide absolute or relative QoS for various NGN services in response to resource reservation requirements of the application service media flows. The X1 and X2 interfaces are new interfaces specified in an embodiment of the present invention.

X3 and X4 interfaces: the Interconnection ACF (I-ACF) interacts with C-RCF via an X3 interface, to perform end-to-end transport resource availability checking and QoS control for resource reservation requirements of application service media flows across operator networks, and provide absolute or relative QoS for various NGN services in response to application requests. The I-ACF may also interact with a

Resource and Admission Control Subsystem (RACS) in any other operator network via an X4 interface, to forward resource reservation requirements of applications across operator networks initiated in the current operator network. The X3 and X4 interfaces are new interfaces specified in an embodiment of the present invention.

I1 interface: the A-ACF interacts with the Network Attachment SubSystem (NASS) via an I1 interface, to obtain user profiles. If there is no local policy database in the A-ACF, the A-ACF can search for operation policy rules in a remote policy server. The I1 interface is a new interface specified in an embodiment of the present invention.

Id interface: the IBCF interacts with the I-ACF via an Id interface, to send resource reservation requirements of cross-operator application service media flows for the transport layer initiated from other operator networks to the I-ACF. This interface can be identical or compatible to the Id interface specified in 3GPP R6 IMS.

The A-ACF performs authentication and makes admission control decisions for resource reservation requests of application service media flows with the following method:

after receiving a resource reservation request from the Gq interface, the A-ACF interacts with the NASS via the Il interface to obtain user profiles, to check whether the resource reservation request conforms to the user profiles; if there is no local policy database in the A-ACF, the A-ACF can search for operation policy rules in a remote policy server and check whether the resource reservation request conforms to the operation policy rules;

if an A-RCF in the access network is provided, the A-ACF forwards the resource reservation request via the X1 interface to the A-RCF, to check the transport resource availability in the access network (i.e., whether there are enough transport resources available in the access network to meet the resource reservation request), and obtains the check result of transport resource availability in the access network from the A-RCF; wherein, the check result may carry information such as QoS class, bandwidth and ingress path assigned to the application service media flow;

if the application service media flow is towards the core network and a C-RCF is provided in the core network, the A-ACF forwards the resource reservation request via the X2 interface to the C-RCF, to check the transport resource availability in the core network (i.e., whether there are enough transport resources available in the core network to meet the resource reservation request), and obtains the check result of transport resource availability in the core network from the C-RCF; wherein, the check result may carry information such as QoS class, bandwidth and ingress path assigned to the application service media flow.

The I-ACF performs authentication and makes admission control decisions for resource reservation requests of cross-operator application service media flows with the following method:

after receiving a resource reservation request via the Id interface, the

I-ACF checks whether the resource reservation request conforms to SLA, operation policy rules, and transport resource availability of the interconnecting link (i.e., checks whether the interconnecting link has enough transport resources available to meet the resource reservation request) between operators;

if the application service media flow is towards the core network and there is a C-RCF in the core network, I-ACF forwards the resource reservation request via the X3 interface to C-RCF, to check the transport resource availability in the core network, and obtains the check result of transport resource availability in the core network from C-RCF; wherein, the check result may carry information such as QoS class, bandwidth and ingress path assigned to the application service media flow.

For any application service in an operator network, RACS performs end-to-end QoS control with the following method:

during the process of creating the application service, the application service control function determines the resource reservation requirements of the application service media flow and sends the requirements to the A-ACFs at initiating end and destination end via the Gq interface respectively;

when receiving the resource reservation request, the A-ACF performs authentication and makes an admission control decision for the resource reservation request with the method 16;

the A-ACF returns the authentication and admission control decision result for the resource reservation request to the application service control function via the Gq interface;

if the admission control decision result is “permit”, the A-ACF sends the admission control parameters to A-BGF in push or pull mode via the Go interface, to control gate operations, packet marking, traffic policing, etc at A-BGF.

For any application service across operator networks, the RACS performs end-to-end QoS control with the following method:

during the process of creating the application service, the application service control function determines the resource reservation requirements of the application service media flow and sends the requirements to the A-ACF via the Gq interface; the IBCF determines the resource requirements of application service media flow and sends the requirements to the I-ACF via the Id interface;

when receiving the resource reservation request, the A-ACF performs authentication and makes an admission control decision for the resource reservation request with the method;

when receiving the resource reservation request, the I-ACF performs authentication and makes an admission control decision for the resource reservation request with the method;

the A-ACF returns the authentication and admission control decision result for the resource reservation request to the application service control function via the Gq interface;

the I-ACF returns the authentication and admission control decision result for the resource reservation request to the IBCF via the Id interface;

if the admission control decision result is “permit”, the A-ACF sends the admission control parameters to the A-BGF in push or pull mode via the Go interface, to control gate operations, packet marking, traffic mapping, etc at A-BGF;

if the admission control decision result is “permit”, the I-ACF sends the admission control parameters to the I-BGF in push or pull mode via the G3 interface, to control gate operations, packet marking, traffic policing, etc. at I-BGF.

The method for resource and admission control according to the embodiment of the present invention enables modification of resource reservation in the application service session. The application service control function sends a resource reservation modification request to the A-ACF via the Gq interface. If the application service is a service across operator networks, the IBCF sends the resource reservation modification request to the I-ACF via the Id interface; the A-ACF and I-ACF modify the original resource reservation and admission control parameters.

The method for resource and admission control according to the embodiment of the present invention requires that the resource reservation should be released after the application service is completed. The application service control function sends a resource release request to the A-ACF via the Gq interface. If the application service is a service cross operator networks, the IBCF sends the resource release request to the I-ACF via the Id interface; the A-ACF and I-ACF release the original resource reservation and admission control parameters.

Though the preferred embodiments of the present invention are described as above, the protective scope of the present invention shall not be limited to these embodiments. Any modifications or alternatives within the disclosure of the present invention by those skilled in the art shall fall in the protective scope of the present invention. Therefore, the protective scope of the present invention shall be defined by the claims.

What is claimed is:

1. A resource and admission control subsystem in a next generation network (NGN), comprising:
an Access Admission Control Function (A-ACF), configured to receive a first resource reservation request from an application service media flow for a transport layer of the NGN, perform an authentication and make a first admission control decision for the first resource reservation request based on a user profile, operation policy rules, and a transport resource availability, and control an Access Border Gateway Function (A-BGF) at a border between an access network of the NGN and a core network of the NGN in accordance with a result of the first admission control decision;
an Interconnection Admission Control Function (I-ACF), configured to receive a second resource reservation request from a cross-operator application service media flow for the transport layer of the NGN, perform an authentication and make a second admission control decision for the second resource reservation request based on the user profile, the operation policy rules, and the transport resource availability, and control an Interconnection Border Gateway Function (I-BGF) at a border between the access network and the core network of the NGN in accordance with a result of the second admission control decision;
a Resource Control Function in access network (A-RCF), configured to check the transport resource availability in accordance with a first transport resource availability check request from the A-ACF, perform checking and resource allocation on the basis of a resource status database, update the resource allocation status, and return a first check result of the transport resource availability;
a Resource Control Function in core network (C-RCF), configured to check the transport resource availability in accordance with a second transport resource availability check request from the A-ACF or the I-ACF, perform checking and resource allocation on the basis of the resource status database, update the resource allocation status, and return a second check result of the transport resource availability;
a Gq interface;
a Go interface;
an Id interface; and
a G3 interface;
wherein an application service control function in a NGN application service subsystem interacts with the A-ACF via the Gq interface, in order to send resource reservation requirements of the application service media flow for the transport layer to the A-ACF through the first resource reservation request;
wherein the A-ACF controls the A-BGF at the border between the access network and the core network via the Go interface, in accordance with the result of the first admission control decision, to perform the functions of: gate opening or closing, wherein the gate indicates a packet filtering by IP address/port, packet marking for outbound traffic, bandwidth reservation and allocation for inbound/outbound traffic, IP address and port translation, policing of inbound traffic, packet filtering-based firewall, and measurement of usage, for the application service media flow;
wherein an interconnection border control function (I-BCF) interacts with the I-ACF via the Id interface, in order to send the resource reservation requirements of the cross-operator application service media flow for the transport layer to the I-ACF through the second resource reservation request;
wherein the I-ACF controls an Interconnection Border Gateway Function (I-BGF) at the border between the two core networks via the G3 interface, in accordance with the result of the second admission control decision, to perform the functions of gate opening or closing, packet marking for outbound traffic, bandwidth reservation and allocation for inbound/outbound traffic, IP address and port translation, policing of inbound traffic, packet filtering-based firewall, and measurement of usage, for the cross-operator application service media flow,
and wherein the A-ACF, I-ACF, A-RCF and C-RCF are logical functional entities, which are separate physical devices or functional modules integrated in other physical devices.

2. The resource and admission control subsystem according to claim 1,
wherein the A-RCF is further configured to acquire status information including topology and bandwidth of transport resources in the access network, control QoS-related traffic handling and resource reservation activities of a Traffic Plane Function in access network (A-TPF), maintain a database of transport resource availability and resource allocation status;
wherein the C-RCF is further configured to acquire status information including topology and bandwidth of transport resources in the core network, control QoS-related traffic handling and resource reservation activities of a Traffic Plane Function in core network (C-TPF), maintain a database of transport resource availability and resource allocation status;
and the resource and admission control subsystem further comprising:
a G2 interface;
a G1 interface;
an X1 interface; and
an X2 interface;
wherein the C-RCF acquires transport resource status information in the core network via the G2 interface, and controls QoS-related traffic handling and resource reservation activities of the C-TPF;
the A-RCF acquires transport resource status information in the access network via the G1 interface, and controls QoS-related traffic handling and resource reservation activities of the A-TPF;
the A-RCF interacts with the A-ACF via the X1 interface, to receive the transport resource availability check request from the A-ACF and return the first check result of the transport resource availability in the access network to the A-ACF; and
the C-RCF interacts with the A-ACF via the X2 interface, to receive the transport resource availability check request from the A-ACF and return the second check result of the transport resource availability in the core network to the A-ACF.

3. The resource and admission control subsystem according to claim 1, further comprising an X3 interface, wherein the C-RCF interacts with the I-ACF via the X3 interface, to receive the transport resource availability check request from the I-ACF and return the second check result of transport resource availability in the access network to the I-ACF.

4. The resource and admission control subsystem according to claim 1, further comprising an X4 interface, wherein the I-ACF interacts with a Resource and Admission Control Subsystem (RACS) in any other operator network via the X4 interface, to forward the resource reservation request of cross-operator application service media flows.

5. The resource and admission control subsystem according to claim 1, further comprising an Il interface, wherein the A-ACF interacts with a Network Attachment Subsystem (NASS) via the Il interface, to obtain user profiles.

6. The resource and admission control subsystem according to claim 1, wherein in each network administrative domain, a centralized Resource Control Function (RCF) or a plurality of RCFs distributed in sub-domains are provided in accordance with the network scale and the type of transport technology;
if a plurality of RCFs distributed in the sub-domains are provided in one administrative domain, the RCFs can interact and coordinate with each other via a universal and extensible protocol interface, so as to accomplish checking of edge-to-edge transport resource availability for the resource reservation request across the entire administrative domain, wherein the RCF is A-RCF or C-RCF.

7. The resource and admission control subsystem according to claim 1, wherein Resource Control Functions (RCFs) in different network administrative domains are interconnected via Admission Control Functions (ACFs); if there is a trusting relationship between the different network administrative domains, the RCFs in the different network administrative domains interface to each other, and exchange information with each other, wherein the ACF is A-ACF or I-ACF and the RCF is A-RCF or C-RCF.

8. The resource and admission control subsystem according to claim 2, wherein in each network administrative domain, a centralized Resource Control Function (RCF) or a plurality of RCFs distributed in sub-domains are provided in accordance with the network scale and the type of transport technology;
if a plurality of RCFs distributed in the sub-domains are provided in one administrative domain, the RCFs can interact and coordinate with each other via a universal and extensible protocol interface, so as to accomplish checking of edge-to-edge transport resource availability for the resource reservation request across the entire administrative domain, wherein the RCF is A-RCF or C-RCF.

9. The resource and admission control subsystem according to claim 2, wherein Resource Control Functions (RCFs) in different network administrative domains are interconnected via Admission Control Functions (ACFs); if there is a trusting relationship between the different network administrative domains, the RCFs in the different network administrative domains interface to each other, and exchange information with each other, wherein the ACF is A-ACF or I-ACF and the RCF is A-RCF or C-RCF.

10. A method for resource and admission control in a next generation network, comprising:
after receiving a resource reservation request from a Gq interface, performing an authentication by an Access Admission Control Function (A-ACF), to check whether the resource reservation request conforms to operation policy rules and whether the resource reservation request conforms to user profiles;
if a Resource Control Function in access network (A-RCF) is provided, forwarding the resource reservation request from the A-ACF to the A-RCF via an X1 interface to check the transport resource availability in the access network, and obtaining a first check result of transport resource availability in the access network from the A-RCF; the first check result carrying QoS class, bandwidth and ingress path information assigned to an application service media flow;
if the application service media flow is towards a core network and a Resource Control Function in core network (C-RCF) is provided, forwarding the resource reservation request from the A-ACF to the C-RCF via an X2 interface to check the transport resource availability in the core network, and obtaining a second check result of transport resource availability in the core network from the C-RCF; the second check result carrying QoS class, bandwidth and ingress path information assigned to the application service media flow;
making an admission control decision by the A-ACF in accordance with the check result of operation policy rules, the check result of user profiles, the first check result of transport resource availability and the second check result of transport resource availability, and determining admission control parameters for the application service media flow; the admission control parameters including gate control, bandwidth allocation, QoS marking, and ingress path information;
returning the admission control decision result for the resource reservation request from the A-ACF to an application service control function via a Gq interface;
if the admission control decision result is “permit”, sending the admission control parameters from the A-ACF to an Access Border Gateway Function (A-BGF) in push or pull mode via a Go interface, to control gate operations, packet marking, and traffic mapping at the A-BGF.

11. The method according to claim 10, wherein performing an authentication by an Access Admission Control Function (A-ACF), to check whether the resource reservation request conforms to operation policy rules and whether the resource reservation request conforms to user profiles further comprises:
if the operation policy rules are not stored locally, the A-ACF searches in a remote policy server, to obtain operation policy rules related with the service.

12. The method according to claim 10, wherein performing authentication by an Access Admission Control Function (A-ACF), to check whether the resource reservation request conforms to operation policy rules and whether the resource reservation request conforms to user profiles further comprises:
if the user profiles are not stored locally, the A-ACF interacts with a Network Attachment Subsystem (NASS) via the Il interface, to obtain user profiles related with the service.

13. The method according to claim 10, wherein for any cross-operator application service media flow, the method further comprises:
after receiving a second resource reservation request via an Id interface, performing authentication by an I-ACF, to check whether the second resource reservation request conforms to a Service Level Agreement (SLA), the operation policy rules, and the transport resource availability of interconnecting link between operators;
if the application service media flow is towards the core network and a C-RCF is provided in the core network, forwarding the second resource reservation request from the I-ACF to the C-RCF via an X3 interface to check the transport resource availability in the core network, and obtaining the check result of transport resource availability in the core network from the C-RCF; the check result carrying QoS class, bandwidth and ingress path information assigned to the application service media flow;
making a second admission control decision by the I-ACF in accordance with a check result of service level agreement, a second check result of operation policy rules, and a check result of transport resource availability between operators, and determining second admission control parameters for the cross-operator application service media flow; the second admission control parameters including gate control, bandwidth allocation, QoS class, and ingress path information;
returning the second admission control decision result for the second resource reservation request from the I-ACF to an Interconnection Border Control Function (IBCF) via the Id interface;
if the second admission control decision result is “permit”, the I-ACF sending the second admission control parameters to an Interconnection Border Gateway Function (I-BGF) in push or pull mode via a G3 interface, to control gate operations, packet marking, and traffic policing at the I-BGF.

14. The method according to claim 10, further comprising:
during a process of creating an application service session, the application service control function determining the resource reservation requirements of the application service media flow and sending the resource reservation request containing the resource reservation requirements to the A-ACF via the Gq interface;
during the process of the application service session, the application service control function sending a resource reservation modification request to the A-ACF via the Gq interface as required, to instruct the A-ACF to modify original resource reservation and admission control parameters;
when the application service session is completed, the application service control function sending a resource release request to the A-ACF via the Gq interface, to instruct the A-ACFs to release the original resource reservation and admission control parameters.

15. The method according to claim 14, wherein for any cross-operator application service media flow, the method further comprises:
during a process of creating a session of the cross-operator application service, IBCF determining the resource reservation requirements of the cross-operator application service media flow and sending a second resource reservation request containing the requirements to the I-ACF via the Id interface;
during the session of the cross-operator application service, the IBCF sending a resource reservation modification request to the I-ACF via the Id interface as required, to instruct the I-ACF to modify the original resource reservation and admission control parameters;
when the session of the cross-operator application service is completed, the IBCF sending a second resource release request to the I-ACF via the Id interface, to instruct the I-ACF to release the original resource reservation and admission control parameters.

16. A resource and admission control subsystem in a next generation network (NGN), comprising:
an Access Admission Control Function (A-ACF), configured to receive a first resource reservation request from an application service media flow, perform an authentication and make a first admission control decision for the first resource reservation request based on user profile, operation policy rules, and transport resource availability, and control an Access Border Gateway Function (A-BGF) between an access network of the NGN and a core network of the NGN in accordance with a result of the first admission control decision;
an Interconnection Admission Control Function (I-ACF), configured to receive a second resource reservation request from a cross-operator application service media flow, perform an authentication and make a second admission control decision for the second resource reservation request based on a user profile, operation policy rules, and a transport resource availability, and control an Interconnection Border Gateway Function (I-BGF) between the access network and the core network of the NGN in accordance with a result of the second admission control decision;
a Resource Control Function in access network (A-RCF), configured to check the transport resource availability in accordance with a first transport resource availability check request from the A-ACF, perform checking and resource allocation on the basis of a resource status database, update the resource allocation status, and return a first check result of the transport resource availability;
a Resource Control Function in core network (C-RCF), configured to check the transport resource availability in accordance with a second transport resource availability check request from the A-ACF or the I-ACF, perform checking and resource allocation on the basis of the resource status database, update the resource allocation status, and return a second check result of the transport resource availability;
a Gq interface;
a Go interface;
an Id interface; and
a G3 interface;
wherein an application service control function in a NGN application service subsystem interacts with the A-ACF via the Gq interface, in order to send resource reservation requirements of the application service media flow to the A-ACF through the first resource reservation request;
wherein the A-ACF controls the A-BGF via the Go interface;
wherein an interconnection border control function (IBCF) sends the resource reservation requirements of the cross-operator application service media flow to the I-ACF through the second resource reservation request via the Id interface;
and wherein the I-ACF controls the I-BGF via the G3 interface.
